(19) United States
(12) Patent Application Publication
(10) Pub. No.: US 2023/0383942 A1
(43) Pub. Date: Nov. 30, 2023

(54) STEAM GENERATOR TOOL

(71) Applicant: General Energy Recovery Inc., Calgary (CA)

(72) Inventors: Brian Kay, Calgary (CA); Adrien Desmarais, Sherwood Park (CA); Farrell Baird, Calgary (CA); Daniel Thompson, Calgary (CA); Wesley Sopko, Calgary (CA); Kevin Wiebe, Calgary (CA); Bradley Dary, Calgary (CA)

(21) Appl. No.: 18/250,258

(22) PCT Filed: Oct. 25, 2021
(86) PCT No.: PCT/CA2021/051497

§ 371 Date: Apr. 24, 2023

Related U.S. Application Data
(60) Provisional application No. 63/104,825, filed on Oct. 23, 2020.

(51) Int. Cl. F22B 1/18

(52) U.S. Cl. CPC F22B 1/1853; E21B 43/24

(57) ABSTRACT

The invention relates to a tool for generating steam and combustion gases for. The tool is configured to enhance the longevity of its ignitor. The tool may have the ignitor recessed in but open to a wall of the tool's combustion chamber, to thereby protect the ignitor from flame impingement during use. The tool may alternately or in addition have passageways for inputs of air, fuel and/or water extending alongside and annularly around the ignitor, to thereby act to cool the ignitor during use.

### FIELD OF THE INVENTION

The invention relates to a steam generator tool and in particular a steam generator tool with improved durability and utility and a method for using the steam generator tool.

### BACKGROUND

There are numerous oil reservoirs throughout the world which contain viscous hydrocarbons, often called “bitumen”, “tar”, “heavy oil”, or “ultra heavy oil” (collectively referred to herein as “heavy oil”) where the heavy oil can have viscosities in the range of 3,000 to over 1,000,000 centipoise. The high viscosity hinders recovery of the oil since it cannot readily flow from the formation.

For economic recovery, heating the heavy oil, such as with steam injection, to lower the viscosity is the most common recovery method. Normally, heavy oil reservoirs would be produced by cyclic steam stimulation (CSS), steam drive (Drive), and steam assisted gravity drainage (SAGD), where steam is injected from the surface into the reservoir to heat the oil thereby reducing the oil viscosity enough for efficient production.

Surface injection of steam has a number of limitations due to inefficient surface boilers, energy loss in surface lines and energy loss in the well. Standard oil field boilers convert 85 to 90% of the fuel energy to steam, surface pipelines will lose 5 to 25% of the fuel energy depending on length of pipelines and insulation quality and lastly, the wellbore heat losses can be up to 5-15% of the fuel energy depending on well depth and insulating methods in the well. Thus, energy losses can total more than 50% of the fuel energy prior to the steam reaching the reservoir. In deep heavy oil reservoirs, surface steam injection often results in hot water, rather than steam, reaching the reservoir due to heat losses.

In addition, numerous heavy oil reservoirs will not respond to conventional steam injection since many have little or no natural drive pressure of their own. Even when reservoir pressure is initially sufficient for production, the pressure obviously declines as production progresses. Consequently, conventional steaming techniques are of little value in these cases, since the steam produced is at a low pressure, for example, several atmospheres. As a result, continuous injection of steam or a “steam drive” is generally out of the question. As a result, a cyclic technique, commonly known as “huff and puff” has been adopted in many steam injection operations. In this technique, steam is injected for a predetermined period of time, steam injection is discontinued and the well shut in for a predetermined period of time, referred to as a “soak”. Thereafter, the well is pumped to a predetermined depletion point and the cycle repeated. However, the steam penetrates only a very small portion of the formation surrounding the well bore, particularly because the steam is injected at a relatively low pressure.

Another problem with conventional steam generation techniques is the production of air pollutants, namely, CO₂, SO₂, NOₓ and particulate emissions. Several jurisdictions have set maximum emissions for such steaming operations, which are generally applied over wide areas where large heavy oil fields exist and steaming operations are conducted on a commercial scale. Consequently, the number of steaming operations in a given field can be severely limited and in some cases it has been necessary to stage development to limit air pollution.

It has also been proposed to utilize high pressure combustion systems at the surface. In such systems, water is vaporized by the flue gases from the combustor and both the flue gas and the steam are injected down the well bore. This essentially eliminates, or at least reduces, the requirement to address the air pollution from the combustion process as all combustion products are injected into the reservoir and a large portion of the injected pollutants remain sequestered in the oil reservoir. The injected mixture conventionally has a composition of about 60% to 70% steam, 25% to 35% nitrogen, about 4% to 5% carbon dioxide, less than 1% oxygen, depending if excess of oxygen is employed for complete combustion, and traces of SO₂ and NOₓ. The SO₂ and NOₓ, of course, create acidic materials. However, potential corrosion effects of these materials can be substantially reduced or even eliminated by proper treatment of the water used to produce the steam and dilution of the acidic compounds by the injected water.

There is a recognized bonus to such an operation, where a combination of steam, nitrogen and carbon dioxide are utilized, as opposed to steam alone. In addition to heating the reservoir and oil in place by condensation of the steam, the carbon dioxide dissolves in the oil, particularly in areas of the reservoir ahead of the steam where the oil is cold and the nitrogen pressurizes or re-pressurizes the reservoir.

A very serious problem, however, with the currently proposed above ground high pressure system is that it involves complex compression equipment and a large combustion vessel operating at high pressures and high temperatures. This combination requires skilled mechanical and electrical personnel to safely operate the equipment.

One solution to the problems of the heat losses during surface generation and transmittal of the steam-flue gas mixture down the well and air pollution, by generator equipment located at the surface, is to position a steam generator downhole at a point adjacent the formation to be steamed, which injects a mixture of steam and flue gas into the formation. This also has the above-mentioned advantages of increasing the depth at which steaming can be economically and practically feasible and improving the rate and quantity of production by the injection of the steam-flue gas mixture.

While many downhole steam generators have been proposed, current designs are generally very complex causing issues during manufacture and operation. Additionally, current designs require frequent maintenance due to hard water build up or ignitor failures, as the downhole conditions are extreme. Any time a maintenance is required, the tool must be removed from the well which is time consuming and expensive.

A durable steam generator tool is required that can be used downhole.

### SUMMARY OF THE INVENTION

In one aspect the invention relates to tool for generating steam and combustion gases, the tool comprising: a first end configured to receive inputs, the inputs including air, fuel and water; a combustion chamber defined within a base wall and a tubular wall extending from the base wall to an outlet opposing the base wall, the combustion chamber configured for accommodating a flame and providing a channel for combusted products to exit though the outlet; a hole within the base wall, the hole open to the combustion chamber; and an ignitor positioned in the hole and recessed from the combustion chamber, the ignitor configured to ignite fuel and air to generate the flame.

In another aspect the invention relates to a tool for generating steam and combustion gases, the tool comprising: a first end configured to receive inputs, the inputs including air, fuel and water; a tubular wall extending from a base wall to an outlet opposing the base wall, the tubular wall configured for accommodating a flame; a ignitor within the tubular wall configured to ignite fuel and air to generate the flame; a passageway conveying at least one input within the tool, the passageway surrounding an outer circumference of the ignitor.

### BRIEF DESCRIPTION OF THE DRAWINGS

For a better appreciation of the invention, the following Figures are appended:

FIG. 1 is a cross-section view of a steam generator tool with a flame.

FIG. 1B is a cross-section view of an embodiment of an internal structure of the tool.

FIG. 2A is a cross-section view of another steam generator tool in an oil reservoir showing further nozzles and an outer housing.

FIG. 2B is a cross-section view of another steam generator tool in the oil reservoir with mixing apparatus supports and reducer cone optional embodiments.

FIG. 2C is an isometric view of the steam generator tool including mixing apparatus supports and a reducer cone with extension.

FIG. 3A is a perspective view of the steam generator tool showing nozzles on an exterior surface of the tool.

FIG. 3B is a perspective view of the steam generator tool showing nozzles in operation.

FIG. 3C is a perspective view of the steam generator tool showing nozzles and water extension conduits in operation.

FIG. 4A is a top plan view of a steam generator tool as installed and connected to surface with a coiled tubing umbilical.

FIG. 4B is a top plan view of a steam generator tool as installed and connected to surface with an Armorpak multi-conduit umbilical.

FIG. 4C is a top plan view of a steam generator tool installed, connected to surface with a coiled tubing umbilical and with an annular bypass for oxidant input.

FIG. 4D is a cross-section view of the steam generator tool including the annular air bypass.

FIG. 5 is a schematic cross-section view of the steam generator tool in FIG. 1B taken along line a-a.

FIG. 6 is a cross-section view of the steam generator tool showing its internal structure including passageways for fuel, air, water and ignition control.

FIG. 7 is a cross-section view of an embodiment of a holder with a plug shown in phantom as it would be installed in the holder.

FIG. 8A is an end view of a lower portion of a steam generator tool.

FIG. 8B is the steam generator tool portion of FIG. 8A sectioned along line M-M.

FIG. 8C is an enlarged portion of FIG. 8B.

### DETAILED DESCRIPTION

The detailed description and examples set forth below are intended as a description of various embodiments of the present invention and are not intended to represent the only embodiments contemplated by the inventor. The detailed description includes specific details for providing a comprehensive understanding of the present invention. However, it will be apparent to those skilled in the art that the present invention may be practiced without these specific details.

The invention generally relates to a steam generator tool and method of steam generation downhole or on the surface for steam and flue gas injection into an oil reservoir.

While steam injection is often used in the recovery of heavy oil, aspects of the invention are not limited to use in the recovery of heavy oil but are applicable to general steam generation. Applications include but are not limited to steam generation for industrial applications, water purification, soil treatment, etc. In addition, the steam generator tool may be used in multiple configurations, for example, on surface or downhole in vertical, horizontal or other wellbore orientations.

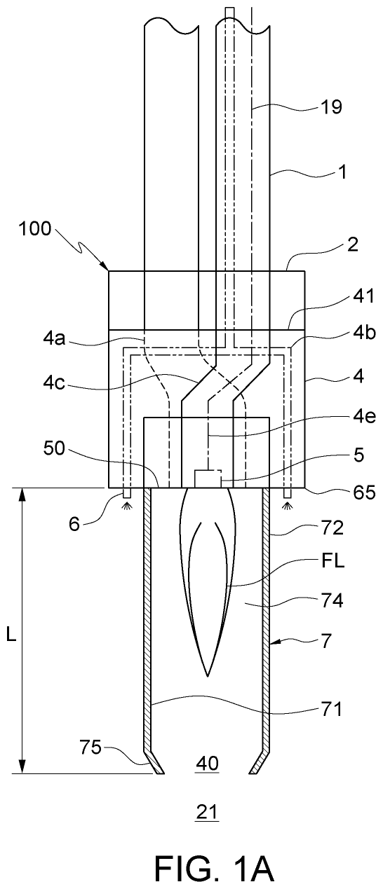

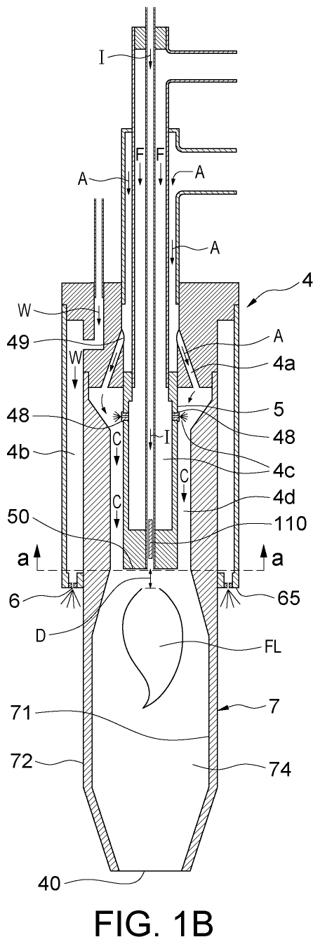

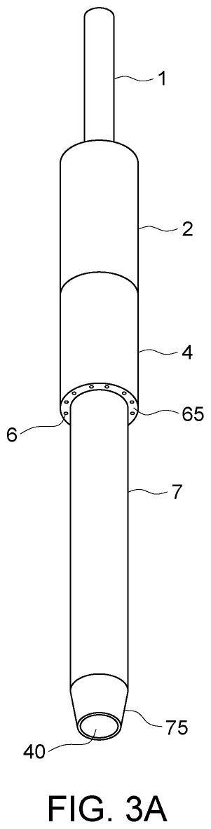

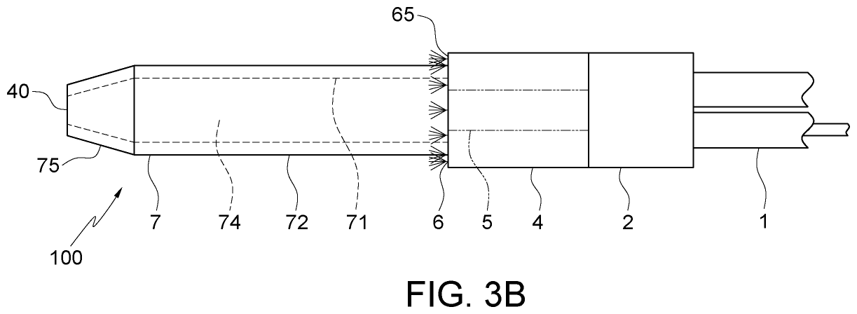

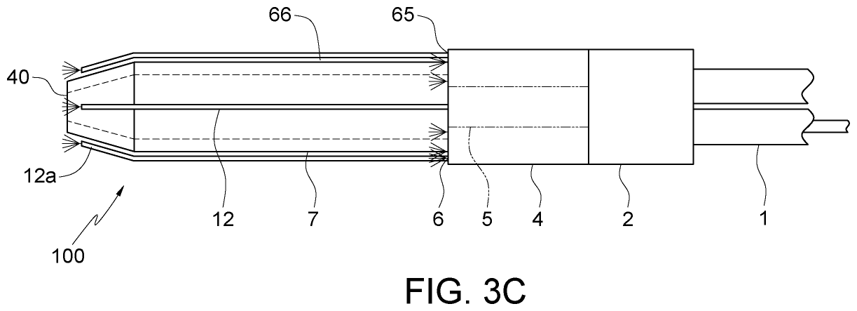

With reference to the drawings, FIGS. 1, 3A and 3B illustrate a steam generator tool 100 configured to receive a supply of fuel and water and, therefrom, to combust the fuel and generate steam from the water. The tool can be used downhole or on surface. In the illustrated embodiment of FIG. 1, tool 100 includes: a tool coupling component 2 configured to receive inputs of water, fuel and oxidant; a flow diversion component 4 coupled to the coupling component and which directs the inputs through the tool; and an ignition component 5 configured to ignite the fuel to produce a flame FL. Tool 100 further includes a combustion chamber 74 configured to accommodate the flame; and a plurality of water nozzles 6 on the external surface of the tool. The nozzles each have an orifice and are configured to eject water onto the outer surface of the combustion chamber 74. The water is converted to steam during operation of the tool 100. The tool coupling component 2 defines a first end, which may be considered the upper end of the steam generator tool, and the combustion chamber is at the second, opposite end of the tool. A long axis of the tool is defined as extending from the first end to the opposite end.

In use, one or more supply lines 1 may be provided for coupling to the tool for delivery of inputs. Lines 1 are received at the tool coupling component 2. The tool's coupling component 2 is configured to receive and couple with lines 1.

The tool coupling component 2 may include a connector or fastener providing a link between the multiple inputs and the flow diversion component 4. The lines 1 may provide pressurized delivery of inputs such as oxidant (such as air), fuel and water, or ignition control to the tool coupling component 2. Inputs may be received by the component 2 with connections that may be appropriately sealed and allow for ease of replacement, repair and modification.

The flow diversion component 4 delivers fuel and air from component 2 to the ignition component 5 and delivers water to the nozzles 6, 12a. The flow diversion component 4 has a first end 41, which receives supplies from the tool coupling component 2. The flow diversion component 4 directs the supplies within the tool for their use and consumption. Fuel and air may be supplied into the tool by the lines 1, diverted into the tool by the flow diversion component 4 and burned in combustion chamber 74. Water may be introduced into the tool from line 1, diverted to water nozzles 6 by the flow diversion component 4, and partially vaporized to steam as the water flows along the combustion chamber outer wall or into the hot combustion gases exiting the combustion chamber.

Specifically, flow diversion component 4 includes a plurality of fluid passageways 4a, 4b, 4c through which the inputs of fuel, water and oxidant can be directed within the tool. The fluid passageways include: an oxidant passageway 4a extending from the first end of the tool, such as from an inlet thereon, toward the combustion chamber, a water passageway 4b extending from the tool's coupling component 2 to the nozzles 6a and a fuel passageway 4c extending from the tool's coupling component 2 toward the combustion chamber 74. In addition to the fluid passageways, there may be a power/control passageway 4e extending from the upper end of the tool to ignition component 5.

The ignition component 5 is configured to ignite the fuel and oxidant flowing into the combustion chamber. For example, ignition component 5 is open to the combustion chamber 74. Once ignited, the fuel and oxidant flows continue to burn within the combustion chamber 74. The ignition component includes an ignitor such as a plug/spark generator, heated surface, a delivery system for pyrophoric or hypergolic liquids (i.e. a liquid that ignites when it comes in contact with air), etc.

The ignition component 5 may be controlled by a control system that determines when the ignition component is operated. The control system may have other operations such as to regulate the stability of the flame or the degree of fuel combustion, or to measure the stoichiometric data, pressure of air and fuel supplied to the tool and sensors located within the flow diversion component 4. The tool may therefore have an ignition control line that couples with a control line 19 in line 1. Control line 19 may be passed through passageway 4e extending from input line 1 to the ignition component. Control line 19 may require an electrical connection 91 at component 2 and 5.

The combustion chamber 74 extends at the second end of the tool opposite the upper end. The combustion chamber is defined within a tubular wall 7 extending at the second end. The tubular wall has a length L extending axially from a base end wall 50 to an open end that forms an outlet from the chamber. Length L may be between 300 and 1000 mm depending on the water and power output requirements.

The combustion chamber wall 7 has an interior surface 71 facing into the combustion chamber and an exterior surface 72, which in the embodiment of FIG. 1 is a portion of the tool's outer surface. Wall 7 may be a hollow tubular structure with the interior surface 71 being the inner diameter of the hollow tubular structure and the exterior surface 72 being the outer surface. In the illustrated embodiment of FIG. 1, the wall is substantially cylindrical, concentric with the long axis of the tool, in which case the interior surface 71 and the exterior surface 72 may each be generally cylindrical. However, other shapes are contemplated as disclosed below.

The diameter of the outlet 40 of the combustion chamber may vary. In one embodiment, the diameter of the outlet 40 is smaller than the diameter of the combustion chamber 74 adjacent to base wall 50. The wall defining the narrowed outlet 40 may be referred to as a combustion nozzle 75. The combustion nozzle 75 influences the exiting combustion gases converging them to pass through the narrower diameter of the combustion nozzle 75. Thus, combustion nozzle 75 generates a backpressure in chamber 74, thereby stopping water from entering the combustion chamber. In addition, combustion nozzle 75 retains air and fuel within the combustion chamber providing complete combustion.

The combustion chamber 74 is defined within the confines of the base wall 50 and the interior surface 71 and its length L is between base wall 50 and outlet 40. The flame resides in the combustion chamber 74, with the combustion products exiting the combustion chamber at the outlet 40.

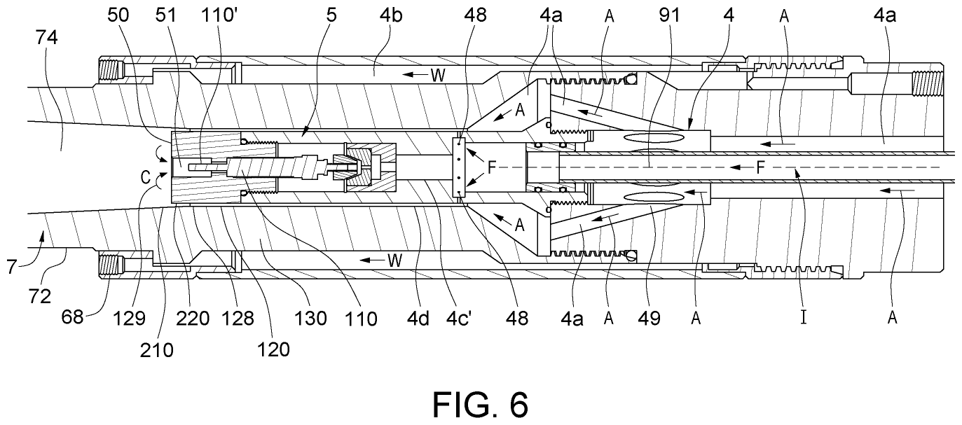

FIG. 1B illustrates an embodiment of an internal structure of the tool, and in particular shows the internal features of flow diversion component 4 and ignition component 5. FIG. 6, illustrates input lines provided for air (A), fuel (F), ignition power/control (I) and water (W) to the tool.

The internal structure of tool may be designed to protect component 5 from failure including from thermal degradation, and to control operation of component 5 as it is used to ignite the fuel and gas mixture to produce the flame and control the velocity of fluid flow to anchor the flame.

In the illustrated embodiment of FIGS. 1B and 6, ignition component 5 and flow diversion component 4 are shown. The ignition component includes: an ignitor, specifically here illustrated as a plug 110, which is configured to ignite the fuel and air, and a holder 120 retaining plug 110 and positioning it substantially concentrically within the combustion chamber 74, relative to interior surface 71 of walls 7.

As noted above, the flow diversion component includes a plurality of fluid passageways 4a, 4b, 4c, acting as conduits through which the inputs of fuel, water and oxidant are directed within the tool. There may be various configurations for the passageways. As noted, there may be a water passageway 4c terminating at openings 68 coupled to water nozzles 6, an ignition control/power passageway 4e coupled to component 5, the air passageway 4a extending from the upper end of the tool to the combustion chamber and the fuel passageway 4c extending from the upper end of the tool to combustion chamber 74, for example opening proximate base wall 50. In the embodiment illustrated in FIGS. 1B and 6, air passageway 4a and fuel passageway 4c may merge within the tool upstream of the combustion chamber to create a combined fuel/air passageway 4d. This combined gas passageway 4d may extend from where passageways 4a and 4c merge to the combustion chamber. As such, the flow diversion component may include a fuel passageway 4c terminating at fuel orifices 48, an air passageway 4a through air orifices 49 and terminating near orifices 48 and a combined gas passageway 4d for conveying the mixture of air and fuel, starting at orifices 48 and terminating at opening 128, which is at the interior surface 71 of the combustion chamber.

It is to be noted that the ignitor, illustrated herein as plug 110, can be a glow plug, spark plug, a heated surface, a delivery system for igniting fluid. During operation, the plug may be electrically energized to generate a heated surface or a spark at the tip of the plug, which can ignite any fuel and air mixture in chamber 74. The ignited air and fuel mixture generates the flame and, thereby, hot combustion gases, which in turn enables vaporization of water to steam. While prior art tools can experience problems with failure of the plug, the present tool positions the plug recessed within base end wall 50, thereby protecting the plug from damage.

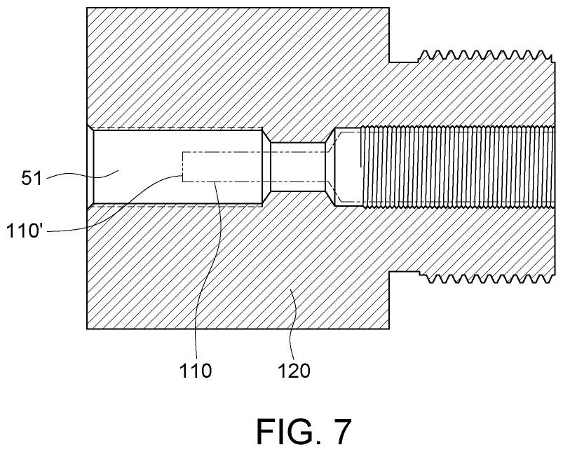

With reference also to FIG. 7, holder 120 is secured in the tool with an end open to chamber 74. Holder 120 is installed within the tool to actually define at least a portion of the base wall. The holder may be configured to secure the plug concentrically and recessed on base wall 50 within the tool. The holder may be coupled to component 5, for example, by threading, so that it may be easily accessed for maintenance and repair. In addition, plug 110 may be coupled to holder 120, for example by threading, so that it may be easily removed for maintenance and repair.

There may be a hole 51, for example, in holder 120 or in base wall generally, in which the plug is recessed. When plug 110 is installed within the tool, the plug is positioned recessed in the hole in base wall 50. In particular, the ignition portion, for example, at least the spark generating or heated surface of plug 110, is recessed back from, but open to, base wall 50 and so, is recessed, axially spaced back, from the main area of the combustion chamber and any generated flame within the chamber is a distance D (FIG. 1B) from the plug. Because the plug 110 is recessed back from combustion chamber 74, this prevents the flame from impinging on the plug. In addition, the greatest heat from the flame is generated at the flame and downstream thereof toward outlet 40. Thus, the recessed position of the plug with the ignition portion exposed in hole 51 in base wall and the remainder of the plug body encompassed within holder 120, protects the plug from the flame and the maximum heat of the flame.

If there is a concern that the fuel and air may not reach plug 110 due to its position in hole 51, the dimensions of the hole can be selected to ensure ignition. Hole 51 has a diameter that provide s sufficient access to plug 110 for ignition. The diameter of the hole may depend on the size, shape and type of plug 110, the fuel and/or air settings, and the operating pressure of the tool. Hole 51 has a depth that also provides sufficient access to the plug. The depth may correspond with the diameter, for example, if hole 51 has a relatively small diameter, then the depth would be shallow to provide sufficient flow of air and fuel to plug 110, however if the hole has a large diameter then the depth of the hole would be deep, relative to the depth of the small diameter hole. As noted, the depth of the hole protects the plug from failure such as by thermal degradation. The ratio between the diameter of the hole and the depth may be 1:2, for example, if the diameter is 12 mm, then the depth is 24 mm.

To further ensure that the flame doesn't impinge on the plug, it can be selectively positioned relative to the openings where the combustible fluids (i.e. fuel and air) enter the combustion chamber. Plug 110 may be proximate to, but not downstream of, where the combustible fluid (i.e. fuel/air) passageways open into the chamber 74. For example, plug's ignition portion may be proximate to opening 128 of combined gas passageway 4d into chamber 74. In one embodiment, the plug's ignition portion, may be proximate to and either axially even to or spaced back from the opening 128 of the combined gas passageway, plug, openings, chamber, if stated another way, relative to base wall 50, the ignition portion, for example, the spark generating or heated surface of plug 110 is positioned recessed into and axially behind but open to, the surface of base wall and opening 128 is at or close to, the base wall, and the flame sets up in chamber 74 axially downstream from opening 128.

In one embodiment, opening 128 is defined between an outer diameter surface 220 of the ignition component, for example an outer diameter surface of holder 120, and an inner diameter of a surrounding housing 210.

Opening 128 may be configured to achieve favorable flow dynamics where the combustible fuel enters the chamber. For example, opening 128 may have a smaller cross-sectional area than the cross-sectional area further upstream in combined gas passageway 4d, to cause an increase in fluid flow velocity at opening 128. In addition, the actual mouth of the opening 128, opens onto a flat surface of base wall 50, for example that is substantially orthogonal to the long axis of the tool (the long axis of the tool can be defined as the long axis through plug 110). Consequently, laminar flow of air and fuel through passageway 4d is perturbed by opening 128, creating turbulence and generating eddy currents 129. Eddy currents, arrows 129, change the direction of air and fuel exiting fluid passageway 4d to circulate back towards hole 51 and plug 110 therein, where fuel and air are ignited to produce the flame. In this embodiment, the mouth of opening, where the outer diameter surface of holder 120 transitions to the base end wall 50, has a sharp corner.

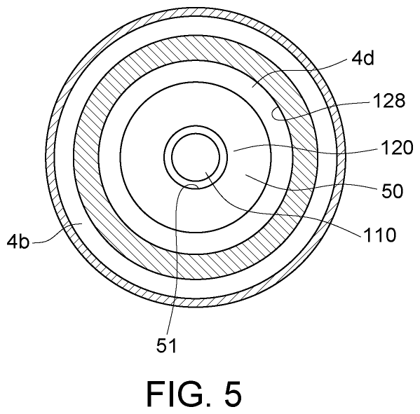

As shown in FIG. 5, passageway 4d and opening 128 can substantially encircle holder 120. Thus, there may be an annular flow of combined gas around the outer diameter surface, the cylindrical perimeter, of holder 120. Passageway 4d is, therefore, an annular gap between holder 120 and housing 210. This is advantageous since, in the event of an occlusion at any point in the annular gap, the combined gas passageway remains open and maintains flow of air and fuel into the combustion chamber, as the passageway is annular. Thus, combined gas passageway 4d provides flow of combined gas substantially in an annular discharge from opening 128 out into chamber 74, the discharge being substantially concentric relative to the plug.

Further, passageways 4a, 4c and 4d channel fluid inside the tool providing a cooling effect to the internal components of the tool. In particular, the internal components 4 and 5 may tend to heat up due to their proximity to the combustion chamber, which anchors the flame and is consequently the hottest portion inside the tool. However, air passageway 4a and fuel passageway 4c that extend within component 4 and combined gas passageway 4d that extends to the combustion chamber each provide a cooling effect by fluid flow to the internal components of the tool. In addition, combined gas in passageway 4d flows through the annular gap surrounding the holder and generates a cooling effect for the entire outer surface of the holder and the plug installed therein. Thus, combined gas flow through passageway 4d further protects the plug 110 from thermal degradation.

The size of the passageways may vary. The clearance of the passageways may be selected to control the velocities and pressures of air, fuel and the combined gas. The clearance may be defined by the exterior diameter 220 of component 5 and the interior diameter of housing 210. The clearance of the passageways provides control of the fluid flow velocity within the interior of the tool and influences the anchoring of the flame on base wall 50. It is noted that in this embodiment, fuel passageway 4c is within a tube that extends though a bore that extends through component 4 and the annular area between the tube and the bore defines the air passageway 4a. Passageway 4a, then diverts though a plurality of sub bores before entering combined gas passageway 4d. Air passageway 4a, overall, has a higher clearance and cross-sectional volume of air flowing though it than passageway 4d. In other words, passageway 4a has a larger total cross-sectional area than passageway 4d. Consequently, air, arrow A, flowing through passageway 4a is constricted into passageway 4d, and as a result, the velocity of air flow is increased through passageway 4d. The increased velocity of combined gas flow through opening 128 anchors the flame near base wall 50 inside the combustion chamber.

In another embodiment fuel, arrows F, ejected from fuel orifice 48 expands into passageway 4d, creating a Joule-Thompson effect at the fuel orifice and cools the internal components of the tool including component 5.

In another embodiment, fuel passageway 4c may extend from the upper end of the tool to an area adjacent the back end of component 5 and plug 110. The portion of fuel passageway adjacent the base end of the plug is identified as extended passageway 4c′. In this case, fuel awaiting passage through fuel orifices 48 can flow through the extended passageway 4c′ close to the base end of the plug. The fuel flow generates a cooling effect at plug 110, thereby again protecting the plug from thermal degradation.

While chamber 74 of FIGS. 6 and 7 is generally cylindrical or gently flaring from base wall 50 toward outlet 40. A flaring of the chamber inner diameter from base wall 50 toward outlet 40 may decrease the velocity and pressure of fluid flow and anchor the flame at base wall 50. In another embodiment, combustion chamber 74 may be shaped so that there is a constriction of the interior diameter of the chamber, where the inner diameter across the chamber decreases from near the base wall 50 to the constriction. The constriction may act to modify the internal pressure and velocity, to thereby to enhance combustion and to adjust the location of the flame. By selecting the location of the constriction along the length L of the combustion chamber, the flame to be anchored between base wall 50 and the constriction or between the constriction and the outlet 40. The constriction may be defined by shaping the inner wall surface of wall 7 or by installation of an insert ring or liner for the chamber. The insert ring or liner has the constriction defined thereon and may be positioned at any point within the combustion chamber.

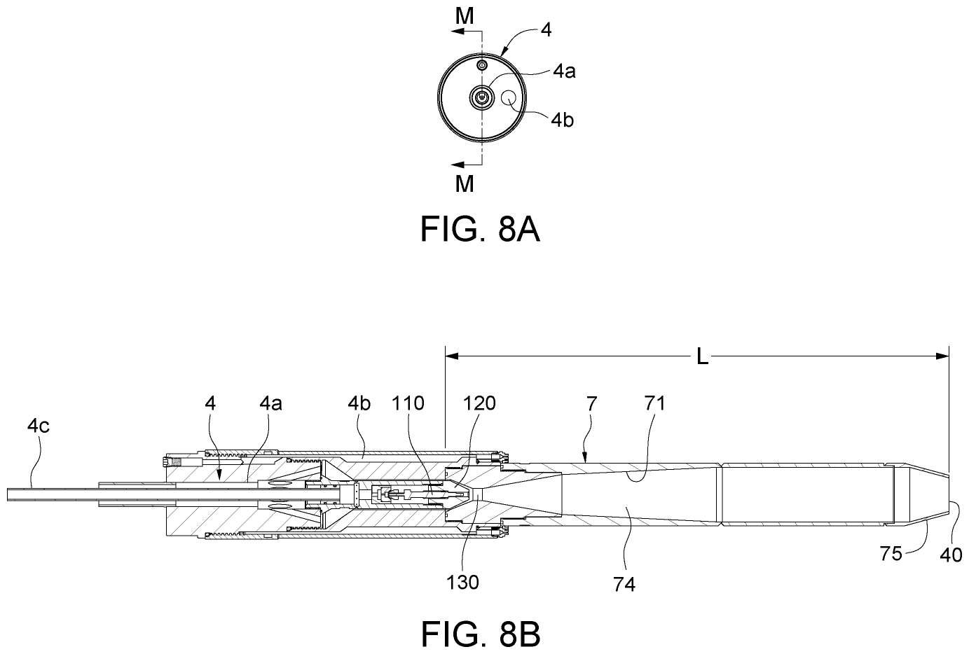

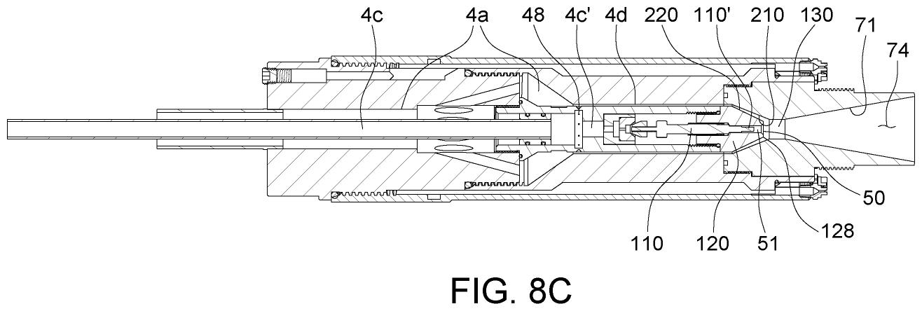

In the embodiment of FIGS. 8A to 8C, a constriction 130 is present in the chamber 74. The constriction causes the inner diameter across the chamber to narrow. As is evident from the drawings, constriction 130 causes the interior surface 71 of combustion chamber 74 to have an hourglass shape, wherein from base wall 50 the combustion chamber inner wall surface 71 tapers gradually inwardly to the narrowest point at the constriction and then the combustion chamber inner diameter flares gradually outwardly toward outlet 40. Outlet 40 may have a combustion nozzle 75 thereon.

In this embodiment, constriction 130 is located close to the base wall 50. It has been found that locating the constriction close to the base wall causes the flame to anchor on the downstream side of constriction, which is in the area between the constriction and outlet 40. Anchoring the flame on the downstream side of constriction 130 spaces the flame from the plug 110 and reduces thermal degradation thereof. This is especially useful at high gas flow rates. The constriction may be located within the first 10% of the length of the combustion chamber, which is the 10% of the length that is closest to the base wall.

While other approaches are possible, constriction 130 is formed on an insert that fits between the wall 7 and the remainder of the tool. In this embodiment, the insert is formed to thread between component 4 and wall 7. As such, the insert may be removed and replaced if repair or a different shape selection (i.e. location or size of constriction) is of interest.

In this embodiment, holder 120 may have a tapered outer diameter surface 220, wherein the outer diameter tapers toward the end that defines base wall 50.

Holder 120 protrudes into the tapered area upstream of constriction 130. As such, opening 128 from passageway 4d is very close to the constriction 130.

The base wall 50 defining end of holder 120 is flat around hole 51 and orthogonal to the long axis of the chamber 74. The igniting portion 110′ of plug 110 is exposed, but recessed within, hole 51. Opening 128 encircles the hole 51 and, due to the frustoconical tapering of outer diameter 220, the combined gas exits passageway in a direction angled inwardly and toward constriction (i.e. conically inwardly). The combined gas exiting opening 128 generates some Eddy action and flows back toward hole 51.

To avoid back pressure, the gap between outer diameter surface 220 and housing inner diameter surface 210 that forms passageway 4d may be become enlarged slightly adjacent opening 128 to maintain the overall cross-sectional area of the passageway 4d.

Intense heat is generated by the flame from where it is anchored and downstream thereof along the flame and the path of the combustion products from the flame. The wall of the combustion chamber therefore becomes extremely hot at a position radially outwardly from where the flame is anchored and downstream thereof to the outlet 40.

While the above-noted internal components are of use in various steam generating tools, applicants have employed that internal configuration in a tool already described in applicant's co-pending application WO 2021/026638, filed Aug. 6, 2020. That tool is described hereinafter, but it is to be understood that the technology described above can be employed in the following tool or elsewhere.

The tool is based on the heat of the flame being transferred from the interior surface 71 to the exterior surface 72.

The water supply is ejected from water nozzles 6 near exterior surface 72 of the wall. The heat at the exterior surface 72 causes the water to be at least partially vaporized to steam. Nozzles 6 are positioned such that water ejected therefrom passes along the outer surface of wall 7 of the combustion chamber. In particular, rather than being positioned to eject water into the combustion chamber where the water could adversely affect the flame, the nozzles are positioned outside the chamber on exterior surface 72. As such, the nozzle orifices open adjacent to the radially outer facing surface 72 of the combustion chamber wall. The nozzles are configured to eject water at least in part axially along the outer surface 72 of the wall 7.

Nozzles 6 located on the exterior surface of the tool, may be positioned at approximately the location where the fuel and oxidant enter the combustion chamber. For example, where air and fuel are combined and ignited, in the combustion chamber, the flame will become anchored at or slightly downstream thereof. Thus, the nozzles 6 may be at approximately the same axial position as the passageway openings of air 4a and fuel 4c or in FIG. 6 embodiment, the opening 128 of combined gas passageways 4d to chamber 74, but the nozzles 6 are on the exterior surface of the tool. The position of the nozzles at the approximately the same axial position as the region of the mixing of fuel and air allows water to be released from a cool area on the exterior surface of the tool.

In the illustrated embodiment, the openings for passageways of air 4a and fuel 4c or in FIG. 6 embodiment, combined gas passageways 4d to chamber 74 are at base wall 50, and therefore nozzles 6 may be located at approximately the location of the base wall 50, which is the upper end of the combustion chamber. The nozzles are positioned near or on the outer surface of the combustion chamber wall radially outwardly from the base wall 50 of the combustion chamber 74. For example, the nozzles may be on the exterior surface of the flow diversion component 4 positioned level, for example coplanar with the ignition component 5 which is at base wall 50. Nozzles 6 are positioned on the exterior surface of component 4 adjacent wall 7 and oriented and configured to spray water therefrom along the combustion wall's exterior surface 72 toward outlet 40. As water flows along the exterior surface of combustion chamber wall 7 towards the outlet 40 of the combustion chamber, the heated exterior surface 72 of the combustion chamber partially vaporises the water into steam.

The position of the nozzles at the same axial position as base wall 50 ensures that water is released from the nozzles before the water reaches the hottest area of the tool, which is on wall 7 between where the flame becomes anchored, and the outlet end 40. Thus, water passageways 4b extend only through coupling component 2 and flow diversion component 4 to reach nozzles 6 and they do not extend along the tool past the hottest area of the tool. In one embodiment, passages 4b terminate at nozzles 6 without passing within wall 7.

The application of water from nozzles 6 to the exterior surface 72 generates a cooling effect at wall 7 where water partially vaporizes to form steam. Thus, this nozzle position protects the combustion chamber wall 7 from thermal degradation and provides a uniform temperature distribution across the combustion chamber wall 7. Also, while prior art tools experienced problems with scale build up and plugging of the water passageways and nozzles, the present tool positions the nozzle s upstream from the hottest area of the tool to avoid over heating and scaling in the water passage and nozzles. While scaling may occur on the exterior surface of the tool, for example, on exterior surface 72 of wall 7, the large surface area ensures such scale does not occlude the water spray and may be absorbed by the flow of water along the length L of the combustion chamber wall 7. While prior tools sometimes required softened water, the current tool can work with impure water sources such as process water, surface water, brackish water, etc.

In one embodiment, exterior surface 72 of wall 7 is treated to resist buildup of scale from water evaporation. For example, the exterior surface may be polished or coated with a non-stick coating such as Teflon™, titanium ceramic compounds or similar materials. This treatment facilitates scale removal during routine maintenance.

Nozzles 6 may be spaced apart about a circumference of the tool such that water is applied around the entire wall exterior surface 72. The number of nozzles depends on the tool power setting, flow rate, expected pressure losses and combustion chamber length.

In one embodiment, as shown in FIG. 3A and FIG. 3B, the nozzles 6 may be installed in a shoulder 65 on the outer surface of the tool. The shoulder may be defined by a change in the tool's outer diameter. The shoulder may be between flow diversion component 4 and combustion chamber wall 7. The shoulder may be an annular surface substantially perpendicular long axis of the tool, which is along the length of the combustion chamber 74. The shoulder 65 faces downward, such that the outer diameter of outer surface substantially at and above base wall 50 is greater than the outer diameter across exterior surface 72 of the combustion chamber wall. Nozzle s 6 are positioned with their orifices opening on the annular step wall such that water is ejected axially along the outer surface of the tool, parallel to the combustion chamber wall 7. Nozzles 6 may be spaced equally around the circumference of the shoulder. The nozzles on the shoulder 65 of the main body may be aimed towards the outlet 40 of the combustion chamber. FIG. 3A shows nozzles 6 in operation, where water is ejected concentrically from about the tool and toward the outlet 40, providing a film of water along the exterior surface 72 of the combustion chamber wall 7. Nozzles spacing on shoulder 65 may be uniform to ensure adequate water coverage of the combustion chamber wall 7. Nozzles 6 may be designed for various spray delivery types including fan, jet, mist, or spray. Additionally, the water pressure and water flow rate may be varied depending on the size of the tool, design criteria and power requirements of the tool.

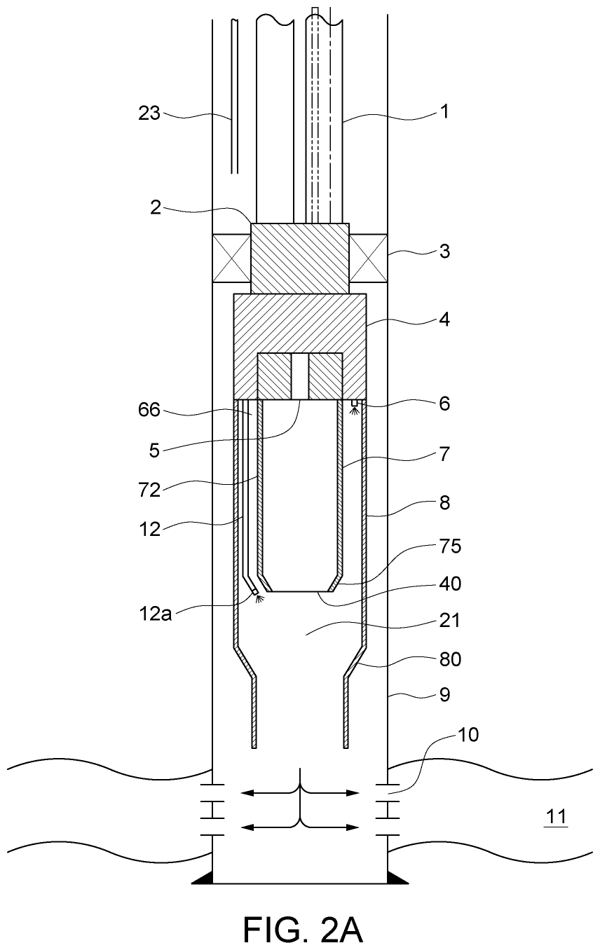

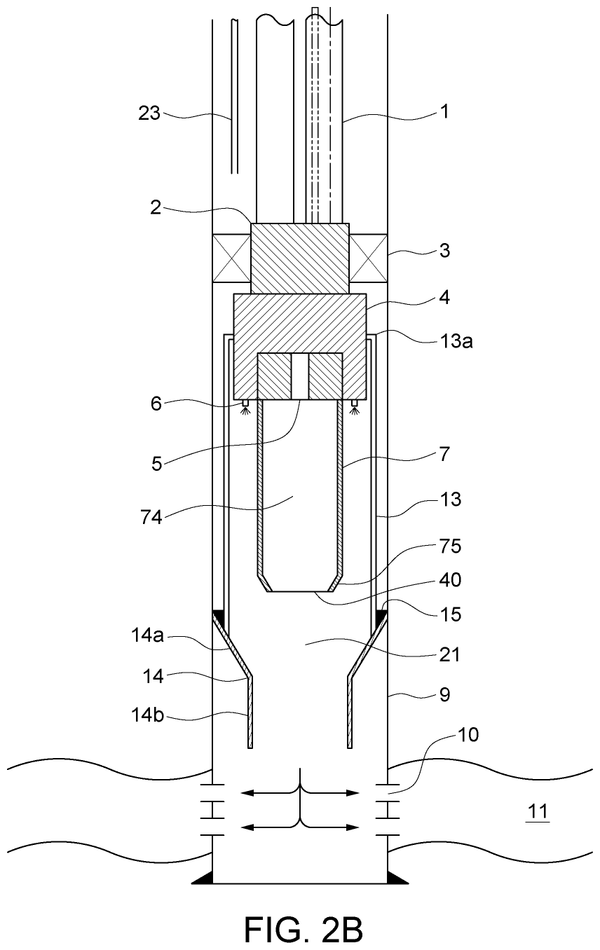

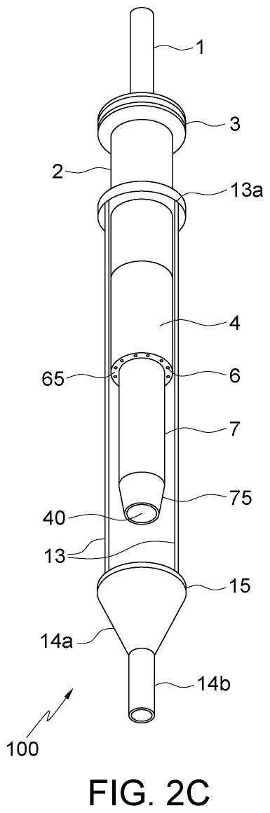

If there is a desire for higher steam quality or the combustion products exiting the outlet are found to be too hot, it may be beneficial to provide further water extension conduits 12 with distal ends having nozzles 12a thereon, as shown in FIGS. 2A and 3C. Extension conduits 12 may be connected to passageways 4b such as those terminating on shoulder 65. As shown in FIG. 3C, each tubular water extension conduit 12 may be connected to component 4, such as connected on to the shoulder 65, spaced apart and interspersed between the nozzles 6, and may extend along length L of the combustion chamber wall 7 to terminate proximate to the outlet 40 of combustion chamber. Water extension conduits 12 may be used in addition to nozzles 6 to provide an additional source of water. Water supplied to the tool may be supplied to and ejected from both water nozzles 6 and water nozzles 12a fitted to extension conduits 12. FIG. 3C shows how water may be ejected simultaneously from water extension conduit nozzles 12a and nozzles 6.

Nozzles 12a are positioned close to the outlet 40, where hot combustion gases exit the tool into space 21. Thus, nozzles 12a of extension conduits 12 can be positioned to eject the water close to or directly into the combustion gases. Water supplied to the tool is directed into water extension conduit 12 and ejected by nozzle 12a into the space 21 where hot combustion gases exit from the outlet 40 of combustion chamber, thereby vaporizing the water to steam. There may be a plurality of water extension conduits 12 and nozzles 12a as shown in FIG. 3C.

Water extension conduits 12 may directly deliver water to the outlet 40 where combustion gases exit 21 and can vaporize the ejected water to steam. Such steam generation in the exiting combustion gases, may also serve to more directly cool the combustion gases. In particular, water extension conduits 12 permit direct cooling of the hot combustion gases 21 ejected from the outlet 40 of the combustion chamber. The water extension conduits 12 may eject water axially relative to the wall or may be angled inward towards the outlet 40 of the combustion chamber to direct water ejected from the nozzles radially between directly radially inwardly or at any angle up to axially away from the outlet. For example, a distal end of the water extension conduits 12 may be angled a at least 45° towards the outlet 40 providing ejection of water into the space 21 of the hot combustion gases exiting the combustion chamber. The number of water extension conduits 12 may vary on the desired steam quality to be injected, size of the well, application and design of the tool. For example, for a tool intended for use in a well having an inner diameter of less than 229 mm or less than 178 mm, between 4 and 8 water extension conduits 12 may be provided.

Water extension conduits 12 with nozzles 12a have the greatest effect at a low power setting, for example below 5 million BTU/hr. In this case, the water ejected from nozzles 12a helps to cool the hot combustion gases exiting the outlet 40 of the combustion chamber.

Water extension conduits 12 are connected to the tool by mechanical coupling or welding. As shown in FIG. 2A, water extension conduits may barely touch or be spaced from the exterior surface 72 of the combustion chamber. In one embodiment, there is a space 66 between each conduit 12 and surface 72. Thus, water extension conduits 12 may be cooled by a film of water supplied from nozzles 6 that may flow into the space 66 between the water extension conduits 12 and the exterior surface 72 of the combustion chamber.

The tool can be used downhole or on surface. When used downhole, the tool is installed with combustion chamber 74 and nozzles 6 open to the area of the well, such as a formation 11 to be steam treated. FIGS. 2A and 2B show tools 100 each installed within a well. An isolating packer 3 secures the tool within the wellbore wall, herein shown as casing 9, and isolates the lower, steam-generating end of the tool from well casing above the packer. Thus, packer 3 maintains the steam and heat from combustion chamber 74 downhole and prevents the steam from flowing upwardly along the annulus away from the oil reservoir 11. The tool may be installed proximate to the perforations 10 and oil reservoir 11 to reduce possible well casing 9 damage and loss of energy to the well casing 9 and other formations above the oil reservoir. Isolating packer 3 has one or more of mechanical, hydraulic, inflatable, swellable or slip less packer elements. The isolating packer 3 may be composed of materials, which may withstand high temperature steam and corrosive gases.

Isolating packer 3 is installed concentrically around the outer surface of the tool, above the tool on a connected but separate tool or on the lines 1. The packer 3 is initially in a retracted position, when not in use or when being tripped into the well, but when in position in the well, it may be set by expanding the packer elements or by differential pressure below or above the packer.

In one embodiment, the isolating packer is installed about a circumference of the tool between the coupling component 2 and the nozzles 6. Thus, when set in the well, the coupling component is uphole of the packer and nozzles 6 and outlet 40 are downhole of packer 3. Packer 3 isolates coupling component 2 from communication with the nozzles except through passageways 4a, 4b, 4c.

When installed in a well, an annular cooling system 23 may be employed uphole of the tool and packer 3.

FIGS. 2A to 2C illustrate further possible steam generator tools with a converging structure for forced mixing of any un-vaporized water, steam and combustion gases downstream of outlet 40 of the combustion chamber. The converging structure forces inward flow of any remaining water and steam into the flue gases exiting outlet, thereby both vaporizing the water and cooling the flue gases. The converging structure includes a conical member on the second end of the tool below outlet. The conical member includes conical side walls that converge from an inlet, open upper end to an outlet, open lower end. The open upper end is wider than both outlet 40 and the conical member's lower end.

In one embodiment, the tool with a converging structure is as illustrated in FIGS. 2B and 2C and includes a reducer cone 14 on the second end spaced from and below outlet 40. In this embodiment, reducer cone 14 is secured below outlet 40 on support arms 13 which are rod-like structures coupled between the tool and the cone. Supports arms 13 are about the same length or longer than the length L of wall 7 such that the cone 14 is further from base wall 50 than outlet 40.

The reducer cone 14 has an open upper end 14a and tapers to a smaller diameter lower outlet 14b. The larger circumference of the cone 14a, which is the open upper end, is closer to outlet 40 than the smaller diameter lower outlet 14b. Thus, the wider upper end faces the outlet 40, whereas the smaller circumference of the cone faces the oil reservoir 11. Cone 14 has a frusto-conical or funnel-shaped solid wall between the open ends 14a, 14b, which forces any un-vaporized water, steam and combustion gases entering the upper end to converge to pass through the smaller diameter lower outlet. In one embodiment, the upper end of reducer cone 14 is about the same diameter as the wellbore casing in which the tool is to be used, which is about the same diameter of packer 3 when set. Therefore, any fluids in area 21 below outlet have to pass through the reducer cone as they move away from the tool. The reducer cone upper end 14a, therefore, rests close to or against the well casing 9. In one embodiment, there is a seal 15 on the upper end of reducer cone 14. The seal may be a ring that extends around the entire circumference of upper end 14a and the ring diameter is selected to be biased against the well casing 9. Seal 15 may be made of a variety of high temperature resilient materials, for example, high temperature rubber compounds, Teflon or similar materials. The smaller diameter lower outlet 14b may be lengthened by a cylindrically shaped solid wall extension of consistent diameter, to control flow dynamics of exiting steam and combustion flue gases. For example, the extension may increase turbulent mixing.

The supports 13 couple the reducer cone to the rest of the tool. There are many options for supports 13. At least, supports 13 act as arms receiving and securing the reducer cone 14 in place proximate to the outlet 40 of the combustion chamber. While supports 13 may be configured to more completely surround exterior outlet 40 and area 21, in one embodiment, supports 13 are a plurality of spaced apart rods with open areas there between, as shown in FIG. 2C. This reduces the weight and material requirements of the tool and leaves annulus about wall 7 as open as possible.

Supports 13 may be further configured to act as centralizers, for example, there being at least three spaced apart support rods that extend axially from at or above shoulder 65 and are diametrically spaced to define an outer diameter that is about the same diameter as the wellbore casing in which the tool is to be used, which is about the same diameter as the upper end of cone 14 and of packer 3, when set.

In one embodiment, supports 13 are connected by a collar 13a, secured above nozzles 6 for example to the outer surface of component 4 below packer 3. Supports 13 then span the length of the main body and extend beyond the combustion chamber wall and outlet to connect to the reducer cone 14 proximate to the outlet 40 of the combustion chamber.

In this embodiment, the well casing 9 is used to contain the water, steam and combustion products within the well below nozzles. For example, water ejected from nozzles 6 flows along the well casing 9, specifically between the combustion chamber wall 7 and casing 9.

If there is concern about tool control or casing damage, another embodiment tool converging structure may be employed such as that illustrated in FIG. 2A. In such a tool, support arms 13 may be replaced with an outer housing 8. The outer housing 8 encases the lower end of the tool and has a reducer cone 80 at the lower end thereof spaced from and below outlet 40 of the combustion chamber. The outer housing may be a cylindrically shaped solid wall. As shown in FIG. 2A, the outer housing 8 with concentrator 80 may be used to contain the water from nozzles, steam and flue gases initially within the tool. For example, water ejected from nozzles 6 creates flow of water between combustion chamber wall 7 and the interior of the outer housing 8. A tool with outer housing 8 may be operated at higher steam qualities (>80%) without damaging the well casing 9. As such, housing 8 becomes sacrificial and protects the casing 9 from the intense heat generated alongside wall 7. Housing 8 can be removably attached to component 4 such that it can be replaced during maintenance.

Water ejected from the nozzles 6 flows between wall 7 and the interior surface of the outer housing. While scale may develop the open annular space tends not to plug up. Optionally a non-stick treatment, such as a coating as noted above, may be applied to the interior surface of the outer housing.

Reducer cone 80 is similar to reducer cone 14 except no seal 15 is needed.

The outer housing increases the outer diameter of the tool and therefore may be used when the diameter of the well casing 9 is large enough to accommodate the outer housing 8. The outer diameter of the outer housing 8 depends on inner diameter of the well casing 9, for example for a typical well under 229 mm the outer housing may be in the range of 114 mm and 180 mm or between 180 mm and 215 mm.

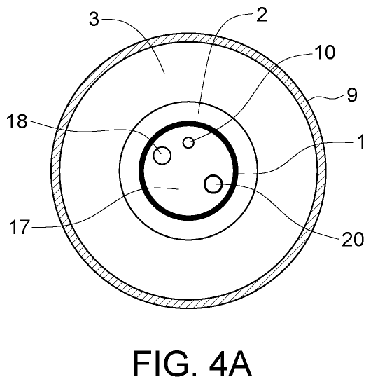

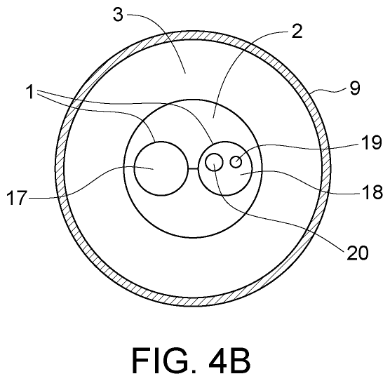

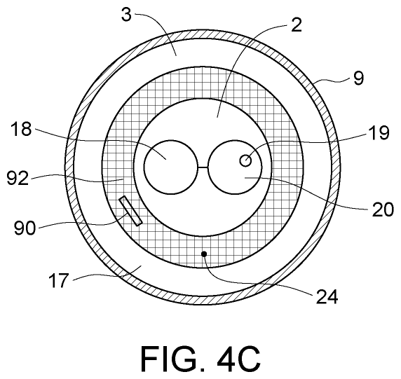

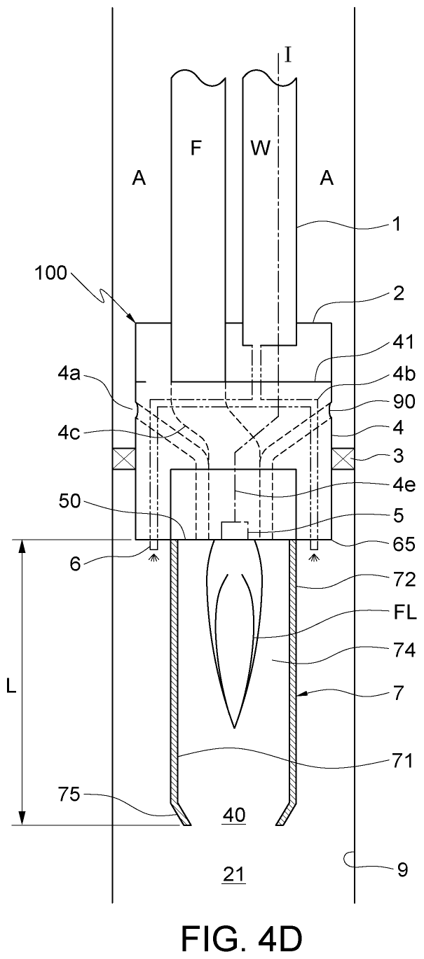

FIGS. 4A to 4C show top plan views of a plurality of tools installed in well casing 9. These Figures illustrate optional configurations for the input lines 1 such as those lines for air 17, fuel 18, ignition control 19 and water 20. In the embodiment of FIG. 4A, all the lines are bundled together with a larger diameter tubing accommodating smaller diameter tubes therein. The fuel, water and control lines 18, 19, 20 are the smaller diameter lines and the air line 17 is effectively the space within the larger diameter tube. The tool 100 coupling component 2 includes a connection site for the larger diameter tube through which air is flowing and connection sites for each of water 20, fuel 18, and ignition control 19.

In another embodiment, a plurality of the lines may be bundled, for example configured as a multi-conduit umbilical 1a, as shown in FIG. 4B. Multi-conduit umbilical 1a may be coupled to the tool at the tool coupling component 2. A multi-conduit umbilical may be bundled using tubing, concentric coiled tubing, flexible braided hose, wraps or Armorpak™ tubing such as is described in U.S. Pat. No. 10,053,927. The outer diameter of the tubing may depend on the pressure requirements of the application of the tool. For example, for heavy oil production, the outer diameter of the tubing may range between 60 and 114 mm and between 15 and 60 mm for Armorpak tubing. Inputs lines 1 such as air 17 or fuel 18 may deliver the largest volume of inputs to the tool when compared to water 20 and therefore may be configured to rigidly secure the tool 100 to the surface during downhole applications.

In an alternative embodiment shown in FIGS. 4C and 4D, the tool is configured to receive air through a port 90 on the tool outer surface rather than through a line. In such an embodiment, tool 100 includes oxidant inlet port 90 on its upper end such as on tool components 2 or 4. While fuel line 18, water line 20 and control line 19 are each connected at separate or bundled sites to tool, air is provided though the annulus of the well and enters tool at port 90. Port 90 may be devoid of any type of connections to input lines, for example, quick connections, threaded connections, Armorpak connections, coiled tubing connections or bundled connections. Port 90 communicates with passageways 4a and 4d that leads to opening 128. The passageways may be configured to allow air to flow from the port 90 to the combustion chamber. Passageway 4d empties into the interior 71 of the combustion chamber. There may be a debris barrier, such as a screen 92 over port 90 to prevent plugging of port 90 with debris or impurities from entering the port and passageway. In this embodiment, there is no line that supplies air to the tool, instead air may be drawn into the tool from the wellbore uphole of the tool. Oxidant such as air may be pumped into the wellbore uphole of the tool. Port 90 provides an annular bypass through tool. The annular bypass may be used, for example, in instances where large volumes of air are required. In these cases, using the annular bypass allows for surface and injection pressures to be reduced to manage the total pressure on the system.

As shown in FIG. 4D, port 90 may be defined by well casing 9, tool coupling component 2 and packer 3. Air entering the annulus of the well casing 9 flows into port 90 and is diverted into the flow diversion component 4. The flow diversion component 4 may have a particular design for annular bypass to accommodate air received through port 90 and delivered to the ignition component 5. During downhole operations, annular bypass provides lower operating pressures at the surface of the well as the flow area in the annulus may be several times larger than the flow area through input lines 1. As a result, annular bypass may be useful when well casing 9 is narrow to provide optimal operating pressures at the surface of the tool. In addition, compressors used to deliver inputs downhole may be more economical when air is delivered through port 90. By using the annulus to deliver air through port 90, supplementary fuel 17 and water 20 may be delivered through input lines 1.

In another aspect of the invention as shown in FIG. 4C, the tool includes a temperature sensor 24, which may be monitored via lines 1 or remotely. Other sensors may also be used, for example, a pressure sensor or chemical injection. Sensors may detect parameters indicative of operations or faults such as overheating or leaks. Chemical may be injected There may be sensors above (as shown) and below the packer 3.

The outer diameter of the steam generator tool 100 may vary depending on the inner diameter of the well casing 9. The steam generator tool must have an outer diameter smaller than the inner diameter of the well casing 9. Typically, the inner diameter of the well may be less than 200 mm or less than 125 mm, in such cases the tool may have a maximum outer diameter of about 190 to 120 mm to fit within well casing 9.

During downhole applications of the steam generator tool, the outer diameter of the tool may be limited by the size of the well casing 9, whereas during surface applications of the tool there is no size limitation.

In another embodiment there is provided, a method for generating steam such as for injection to a reservoir 11 for producing oil from the oil reservoir. The method comprises: supplying air, water, fuel and power to the steam generator tool; igniting the fuel to create a flame within the combustion chamber 74; ejecting water out of the nozzles 6 along the exterior of the combustion chamber wall 7 such that the water partially vaporizes to form steam and flows along an exterior surface 72 of the combustion chamber wall 7 while combustion gases from the flame flow within the combustion chamber through the inner diameter defined within the interior surface 71 of the wall; and mixing the steam and the combustion gases at an outlet 40 of the combustion chamber. The mixture of steam and combustion gases may be communicated to the reservoir.

Supply of air, water, fuel and power to the tool may be achieved using various methods. For example, the multi-conduit umbilical may supply inputs to the tool. Alternatively, the space between the tool and the well casing 9, specifically the annulus may provide a path for inputs such as air, where the tool includes port 90. The ignition component 5 may be used to initiate combustion of the supplied fuel and air to produce the flame within the interior of the combustion chamber. Water flowing into the tool via the multi-conduit umbilical may be ejected through water nozzles 6. Nozzles 6 may be oriented so that the water may be ejected at least in part axially towards the outlet 40 of the combustion chamber. Water flowing along the length L of the heated combustion chamber wall 7 is vaporized to steam.

The steam and combustion gases, and any un-vaporized water, may be directed to converge, for example, by passing through the reducer cone 14, 80 before entering the oil reservoir 11. The reducer cone funnels and forces mixing of the steam and/or water after travelling along the combustion chamber wall 7 and combustion gases exiting the outlet 40 of the combustion chamber. This increases steam quality and reduces flue gas exit temperatures.

Water supplied to the tool 100 may be impure water, for example, non-potable fresh water, brackish water or seawater. The steam generated by the tool 100 may include super-heated steam.

A variety of different fuels may be employed, for example, natural gas, synthetic gas, propane, hydrogen or liquid fuels.

For use in typical oil reservoirs, the pressure of air or gases may be controlled to about 20 atmospheres (1,500 kPa) to about 100 atmospheres (10,500 kPa) and the output of the tool may be controlled to above 25 MINI Btu/hr.

The components of the steam generator tool 100 are simple and flexible permitting ease of use, inspection, repair and modification. The tool has excellent cooling properties and solutions for protecting the ignitor from thermal degradation. The tool and method of using the tool to produce steam reduces or delays environmental pollution. Due to the design and configuration of the components, the tool is able withstand high temperatures and pressures over repeated use. In addition, the tool is capable of pressurizing and/or re-pressurizing the oil reservoir as combustion gases and steam may be injected into the well at various pressures. The high power output of the tool provides extended oil production operations in many applications.

### BROAD CONCEPTS

A. A tool for generating steam and combustion gases, the tool comprising: a first end configured to receive inputs, the inputs including air, fuel and water; a combustion chamber defined within a base wall and a tubular wall extending from the base wall to an outlet opposing the base wall, the combustion chamber configured for accommodating a flame and providing a channel for combusted products to exit though the outlet; a hole within the base wall, the hole open to the combustion chamber; and an ignitor positioned in the hole and recessed from the combustion chamber, the ignitor configured to ignite fuel and air to generate the flame.
B. The tool of any of paragraphs A-P, further comprising a passageway for conveying at least one of the fuel and air inputs to the combustion chamber, the passageway configured to provide a flow of fluid around the ignitor.
C. The tool of any of paragraphs A-P, wherein the flow of fluid is annular around the ignitor.
D. The tool of any of paragraphs A-P, further comprising a holder positioning the ignitor concentrically relative to the tubular wall defining the combustion chamber.
E. The tool of any of paragraphs A-P, further comprising an annular gap around an outer diameter of the holder and the annular gap defines a passageway for conveying at least one of the fuel and air inputs to the combustion chamber.
F The tool of any of paragraphs A-P, further comprising a constriction in the combustion chamber.
G. The tool of any of paragraphs A-P, wherein the hole extends axially concentric with a long axis of the combustion chamber and the base wall is orthogonal relative to the long axis.
H. A tool for generating steam and combustion gases, the tool comprising: a first end configured to receive inputs, the inputs including air, fuel and water; a tubular wall extending from a base wall to an outlet opposing the base wall, the tubular wall configured for accommodating a flame; a ignitor within the tubular wall configured to ignite fuel and air to generate the flame; and a passageway conveying at least one input within the tool, the passageway surrounding an outer circumference of the ignitor.
I. The tool of any of paragraphs A-P, further comprising a holder in which the ignitor is installed, the holder coupled at, and defining a portion of, the base wall and the passageway is an annular gap around an outer diameter of the holder.
J. The tool of any of paragraphs A-P, wherein the passageway is for a combined fuel and air input to the combustion chamber.
K. The tool of any of paragraphs A-P, further comprising an annular water passageway extending substantially concentrically around, but fluidly isolated from, the passageway.
L. The tool of any of paragraphs A-P, further comprising: an air passageway extending from the first end into the tool; a fuel passageway extending from the first end into the tool; the air passageway and the fuel passageway merging at a junction within the tool and the passageway is for a combined flow of fuel and air.
M. The tool of any of paragraphs A-P, wherein the fuel passageway terminates at a plurality of nozzles leading into the junction and the junction has an internal volume greater than the fuel passageway to thereby allow fuel from the fuel passageway to expand into the junction.
N. The tool of any of paragraphs A-P, further comprising a fuel passageway extending from the first end to a position open to a back side of the ignitor.
O. The tool of any of paragraphs A-P, wherein the ignitor is recessed in a hole in the base wall such that the ignitor is open to but spaced back from the base wall.
P. The tool of any of paragraphs A-P, wherein the passageway has an outlet configured to discharge the in an annular discharge that is substantially concentric relative to a long axis of the ignitor.

The description and examples are to enable the person of skill to better understand the invention. The invention is not to be limited by the description and examples but instead given a broad interpretation.

We claim:

1. A tool for generating steam and combustion gases, the tool comprising:
a first end configured to receive inputs, the inputs including air, fuel and water;
a combustion chamber defined within a base wall and a tubular wall extending from the base wall to an outlet opposing the base wall, the combustion chamber configured for accommodating a flame and providing a channel for combusted products to exit though the outlet;
a hole within the base wall, the hole open to the combustion chamber; and
an ignitor positioned in the hole and recessed from the combustion chamber, the ignitor configured to ignite fuel and air to generate the flame.

2. The tool of claim 1, further comprising a passageway for conveying at least one of the fuel and air inputs to the combustion chamber, the passageway configured to provide a flow of fluid around the ignitor.

3. The tool of claim 2, wherein the flow of fluid is annular around the ignitor.

4. The tool of claim 1, further comprising a holder positioning the ignitor concentrically relative to the tubular wall defining the combustion chamber.

5. The tool of claim 4, further comprising an annular gap around an outer diameter of the holder and the annular gap defines a passageway for conveying at least one of the fuel and air inputs to the combustion chamber.

6. The tool of claim 1, further comprising a constriction in the combustion chamber.

7. The tool of claim 1, wherein the hole extends axially concentric with a long axis of the combustion chamber and the base wall is orthogonal relative to the long axis.

8. A tool for generating steam and combustion gases, the tool comprising:
a first end configured to receive inputs, the inputs including air, fuel and water;
a tubular wall extending from a base wall to an outlet opposing the base wall, the tubular wall configured for accommodating a flame;
a ignitor within the tubular wall configured to ignite fuel and air to generate the flame; and
a passageway conveying at least one input within the tool, the passageway surrounding an outer circumference of the ignitor.

9. The tool of claim 8, further comprising a holder in which the ignitor is installed, the holder coupled at, and defining a portion of, the base wall and the passageway is an annular gap around an outer diameter of the holder.

10. The tool of claim 9, wherein the passageway is for a combined fuel and air input to the combustion chamber.

11. The tool of claim 10, further comprising an annular water passageway extending substantially concentrically around, but fluidly isolated from, the passageway.

11. The tool of claim 8, further comprising:
an air passageway extending from the first end into the tool; and
a fuel passageway extending from the first end into the tool;
the air passageway and the fuel passageway merging at a junction within the tool and the passageway is for a combined flow of fuel and air.

12. The tool of claim 11, wherein the fuel passageway terminates at a plurality of nozzles leading into the junction and the junction has an internal volume greater than the fuel passageway to thereby allow fuel from the fuel passageway to expand into the junction.

13. The tool of claim 8, further comprising a fuel passageway extending from the first end to a position open to a back side of the ignitor.

14. The tool of claim 8, wherein the ignitor is recessed in a hole in the base wall such that the ignitor is open to but spaced back from the base wall.

15. The tool of claim 14, wherein the passageway has an outlet configured to discharge the at least one input in an annular discharge that is substantially concentric relative to a long axis of the ignitor.
